(19) United States
(12) Patent Application Publication
(10) Pub. No.: US 2018/0003356 A1
(43) Pub. Date: Jan. 4, 2018

(54) LIGHTING APPARATUS AND VEHICLE HEADLIGHT COMPRISING LIGHTING APPARATUS

(71) Applicant: OSRAM GmbH, Munich (DE)

(72) Inventors: Jasmin Muster, Heidenheim (DE); Stephan Schwaiger, Ulm (DE); Ricarda Schoemer, Zusmarshausen (DE); Oliver Woisetschlaeger, Sontheim (DE); Oliver Hering, Niederstotzingen (DE)

(21) Appl. No.: 15/633,790

(22) Filed: Jun. 27, 2017

(30) Foreign Application Priority Data
Jul. 4, 2016 (DE) 102016212070.0

(51) Int. Cl. F21S 8/10; F21V 9/08; B60Q 1/04; F21Y 2115/30

(52) U.S. Cl. CPC F21S 48/1225; F21V 9/08; F21S 48/1145; B60Q 1/04; F21Y 2115/30

(57) ABSTRACT

In various embodiments, a lighting apparatus is provided. The lighting apparatus includes at least one laser light source, and at least one light wavelength conversion element for the wavelength conversion of laser light from the at least one laser light source. The lighting apparatus has a structure configured to homogenize the light color of the light emitted by the lighting apparatus.

### CROSS-REFERENCE TO RELATED APPLICATION

This application claims priority to German Patent Application Serial No. 10 2016 212 070.0, which was filed Jul. 4, 2016, and is incorporated herein by reference in its entirety.

### TECHNICAL FIELD

Various embodiments relate generally to a lighting apparatus having at least one laser light source and a light wavelength conversion element for the partial or complete wavelength conversion of the laser light emitted by the at least one laser light source. Moreover, various embodiments relate to a vehicle headlight having at least one such lighting apparatus.

### BACKGROUND

One or a plurality of such lighting apparatuses serve for example as light sources in a vehicle headlight for generating white light in accordance with the ECE standard ECE/324/Rev. 1/Adb.No. 48/Rev. 12 or as light sources for medical applications or for microscopy or spectroscopy, or for projection or effect entertainment lighting.

Such lighting apparatuses generally emit light that is inhomogeneous in terms of color because, for example, the wavelength conversion of the laser light in the light wavelength conversion element is locally inhomogeneous on account of light scattering of the laser light in the light wavelength conversion element and, as a result, even the proportions of non-wavelength-converted laser light and wavelength-converted light in the light emitted by the light wavelength conversion element vary locally over the light-emitting surface of the light wavelength conversion element. In particular, that proportion of the wavelength-converted light which is emitted by regions of the light-emitting surface of the light wavelength conversion element which are at a comparatively large distance from the impingement location of the laser light on the light wavelength conversion element is higher than that proportion of the wavelength-converted light which is emitted by regions of the light-emitting surface of the light wavelength conversion element which are at a comparatively small distance from the impingement location of the laser light on the light wavelength conversion element.

### SUMMARY

In various embodiments, a lighting apparatus is provided. The lighting apparatus includes at least one laser light source, and at least one light wavelength conversion element for the wavelength conversion of laser light from the at least one laser light source. The lighting apparatus has a structure configured to homogenize the light color of the light emitted by the lighting apparatus.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a lighting apparatus in accordance with the first embodiment in a schematic, partly sectional illustration;

FIG. 2 shows a plan view of a surface of the light wavelength conversion element of the lighting apparatus depicted in FIG. 1;

FIG. 3 shows the thickness of the filter of the lighting apparatus depicted in FIG. 1 as a function of the distance to the center of the light wavelength conversion element;

FIG. 4 shows a lighting apparatus in accordance with the second embodiment in a schematic illustration;

FIG. 5 shows a cross section through the filter of the lighting apparatus depicted in FIG. 4 in a schematic illustration and the dependence of the thickness of the filter on the distance to the center of the light wavelength conversion element;

FIG. 6 shows a lighting apparatus in accordance with the third embodiment in a schematic illustration;

FIG. 7 shows the thickness of the filters of the lighting apparatus depicted in FIG. 6 as a function of the distance to the center of the light wavelength conversion element;

FIG. 8 shows a lighting apparatus in accordance with the fourth embodiment in a schematic, partly sectional illustration;

FIG. 9 shows a schematic illustration of the filter edge of the filter of the lighting apparatus depicted in FIG. 8;

FIG. 10 shows a lighting apparatus in accordance with the fifth embodiment in a schematic, partly sectional illustration;

FIG. 11 shows a lighting apparatus in accordance with the sixth embodiment in a schematic, partly sectional illustration;

FIG. 12 shows a lighting apparatus in accordance with the seventh embodiment in a schematic, partly sectional illustration;

FIG. 13 shows a lighting apparatus in accordance with the eighth embodiment in a schematic, partly sectional illustration.

### DESCRIPTION

The following detailed description refers to the accompanying drawings that show, by way of illustration, specific details and embodiments in which the invention may be practiced.

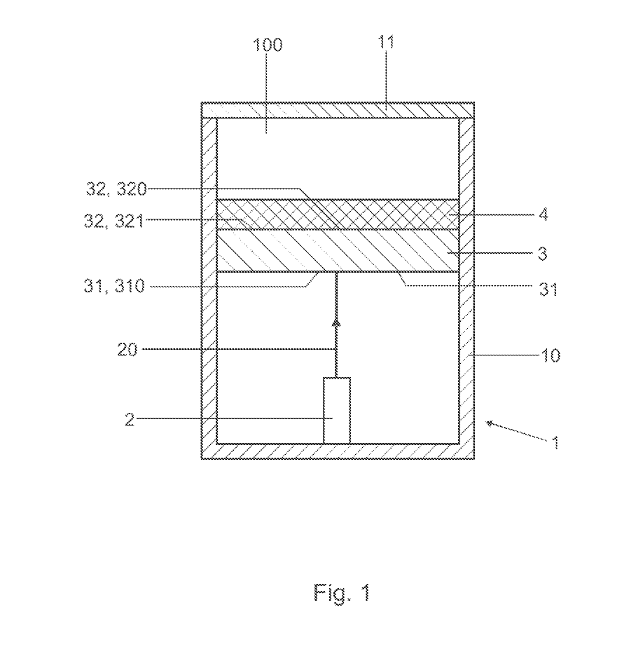

Details of a lighting apparatus in accordance with a first embodiment are illustrated schematically and in a partly sectional view in FIG. 1 to FIG. 3.

The lighting apparatus 1 in accordance with the first embodiment has a cylindrical housing 10 having a light exit opening 100, which is formed by a transparent housing wall or transparent cover 11 at an end side of the housing 10, a laser diode device 2 arranged within the housing 10, and a light wavelength conversion element 3 and also a filter 4. The proportions of the individual components of said lighting apparatus 1 are not illustrated in a manner true to scale in FIG. 1.

The laser diode device 2 includes a laser diode, which during its operation generates blue light having a wavelength of 450 nanometers and an optical power in the range of 1 to 4 watts, and an optical unit disposed downstream of the laser diode and serving for shaping the laser beam emitted by the laser diode.

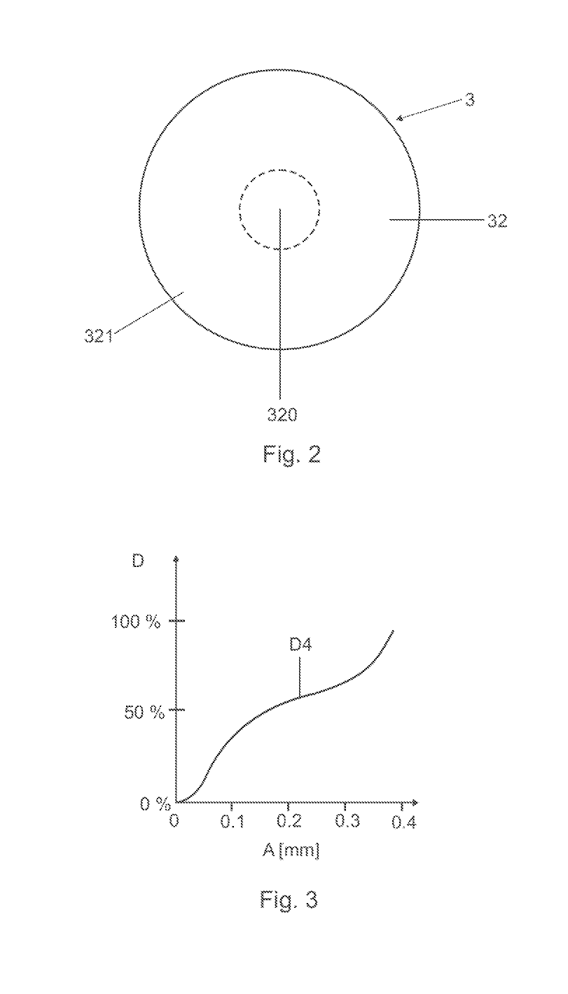

The light wavelength conversion element 3 includes or essentially consists of cerium-doped yttrium aluminum garnet (YAG:Ce) and a transparent substrate, for example sapphire (not illustrated). It is embodied as a circular disk having a diameter of 0.8 mm. The light wavelength conversion element 3 is arranged within the housing 10 between the laser diode device 2 and the light exit opening 100, such that laser light 20 emitted by the laser diode device 2 impinges centrally on an underside 31 of the circular-disk-shaped light wavelength conversion element 3, said underside facing away from the light exit opening 100. A central surface region 310 of the underside 31 of the light wavelength conversion element 3 is illuminated with laser light 20 from the laser diode device 2. A central surface region 320 at a top side 32 of the light wavelength conversion element 3, said top side facing the light exit opening 100, corresponds to the central surface region 310 at the underside 31 of the light wavelength conversion element 3. FIG. 2 schematically illustrates a plan view of the top side 32 of the light wavelength conversion element 3 without filter 4. The laser light 20 impinging on the underside 31 in the central surface region 310 penetrates through the light wavelength conversion element 3 and in the process is converted proportionally into light of other wavelengths with an intensity maximum in the wavelength range of 560 nanometers to 590 nanometers, which corresponds to the spectral range of yellow light, such that at the top side 32 of the light wavelength conversion element 3 light emerges which is a mixture of non-wavelength-converted blue laser light and wavelength-converted light and is therefore also referred to hereinafter as mixed light. In this case, the central surface region 320 at the top side 32 of the light wavelength conversion element 3 emits a higher proportion of non-wavelength-converted blue laser light than the edge region 321 of the top side 32 of the light wavelength conversion element 3. Accordingly, the mixed light emitted by the top side 32 of the light wavelength conversion element 3 has an inhomogeneous color distribution. In various embodiments, the blue proportion in the mixed light emitted by the central surface region 320 is greater than the blue proportion in the mixed light emitted by the edge region 321 of the top side 32 of the light wavelength conversion element 3. Moreover, the yellow proportion in the mixed light emitted by the central surface region 320 is less than the yellow proportion in the mixed light emitted by the edge region 321 of the top side 32 of the light wavelength conversion element 3. This inhomogeneity of the light color distribution may be partly or completely eliminated with the aid of the filter 4.

The filter 4 is embodied as an absorption filter that is coordinated with the wavelength of the wavelength-converted light, such that it predominantly absorbs light wavelength-converted at the light wavelength conversion element 3. The absorption filter 4 is embodied as a coating on the top side 32 of the light wavelength conversion element 3 and consists of glass which is transparent to blue light and is provided with dopants that primarily absorb long-wave light. A suitable dopant used is cobalt oxide (CoO), for example, which absorbs principally light from the spectral range of yellow and red light.

FIG. 3 schematically illustrates the layer thickness D4 of the filter 4 as a function of the distance from the center of the light-emitting surface at the top side 32 of the light wavelength conversion element 3. The layer thickness D in percent relative to a maximum value Dₘₐₓ of the layer thickness D4 of the filter 4 is plotted on the vertical axis, and the distance A from the center of the light-emitting surface at the top side 32 of the light wavelength conversion element 3 in millimeters is plotted on the horizontal axis. The layer thickness D4 of the filter 4 proceeding from the center of the light-emitting surface on the top side 32 of the circular-disk-shaped light wavelength conversion element 3 increases in a radial direction up to the maximum value Dₘₐₓ, which is attained at the edge of the light wavelength conversion element 3. The layer thickness of the filter 4 is indicated in percent in FIG. 3, wherein the maximum value Dₘₐₓ of the layer thickness serves as reference. The layer thickness D4 is 0% of the maximum value Dₘₐₓ in the center of the top side 32 and 100% of the maximum value Dₘₐₓ at the edge. The laser beam 20 emitted by the laser diode device 2 is directed at the center of the underside 31 of the light wavelength conversion element 3 and penetrates through the light wavelength conversion element 3. The laser beam is scattered and proportionally wavelength-converted light is generated. The layer thickness D4 of the filter 4 is embodied in such a way that the top side 32 of the light wavelength conversion element 3 together with the filter 4 emits everywhere light whose color coordinates are coordinated with that color locus of the light emitted by the top side 32 of the light wavelength conversion element 3 which has the highest blue proportion. The light color of the light emitted by the light wavelength conversion element 3 is substantially homogeneous over the top side 32 of the light wavelength conversion element 3 provided with the filter 4.

The maximum value Dₘₐₓ of the layer thickness D4 of the filter 4 is dependent on the desired absorptance of the filter 4 and is at a value in the value range of 1 micrometer to 10 millimeters and e.g. at a value in the value range of 10 micrometers to 1 millimeter. The absorption of the filter 4 follows the Lambert-Beer law. Accordingly, the intensity of the wavelength-converted light in the filter layer decreases exponentially with the layer thickness of the filter 4. The blue laser light is hardly absorbed or not absorbed at all.

The absorption filter 4 can be constructed from a plurality of layers of different thicknesses and extents that are successively applied to the top side 32 of the light wavelength conversion element 3.

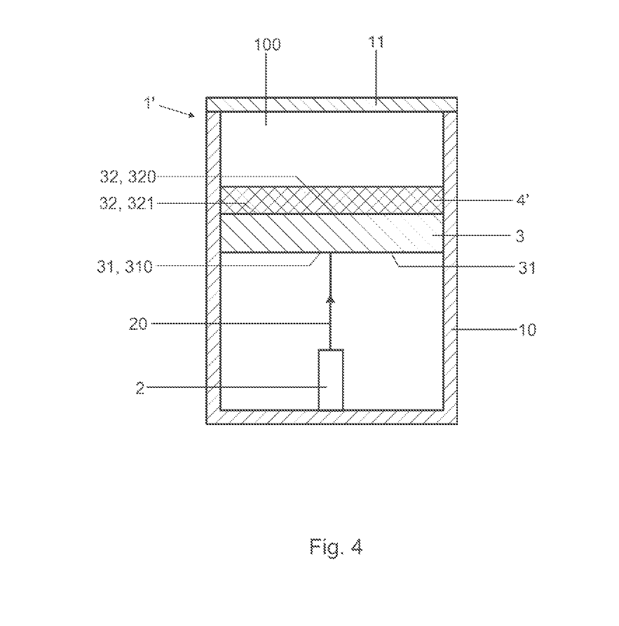

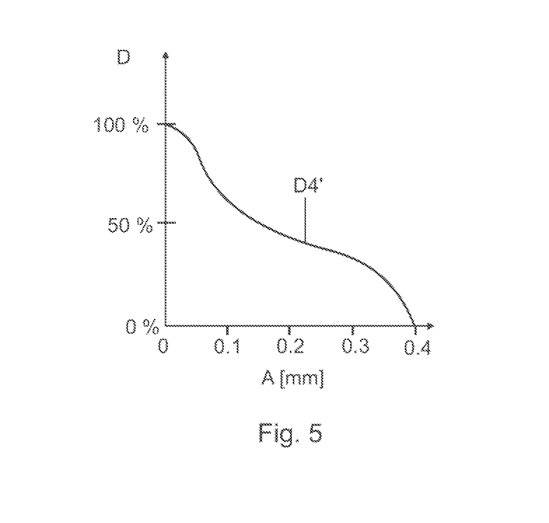

FIG. 4 and FIG. 5 schematically illustrate a lighting apparatus in accordance with the second embodiment. The lighting apparatus in accordance with the second embodiment differs from the above-described lighting apparatus in accordance with the first embodiment only in the different embodiment of the filter 4′. The lighting apparatuses in accordance with the first and second embodiments correspond in all other details. Therefore, in FIG. 1 and FIG. 4 identical components of the lighting apparatuses are designated by the same reference signs and, for the description thereof, reference is made to the description of the first embodiment of the lighting apparatus according to various embodiments.

The lighting apparatus 1′ in accordance with the second embodiment has a cylindrical housing 10 having a light exit opening 100, which is formed by a transparent housing wall or transparent cover 11 at an end side of the housing 10, a laser diode device 2 arranged within the housing 10, and a light wavelength conversion element 3 and also a filter 4′. The proportions of the individual components of said lighting apparatus 1′ are not illustrated in a manner true to scale in FIG. 4.

The housing 10, including light exit opening 100 and transparent cover 11, and also the laser diode device 2 and the light wavelength conversion element 3 are embodied identically to the lighting apparatus in accordance with the first embodiment. For the description thereof, reference is made to the description of these components of the first embodiment.

The filter 4′ of the lighting apparatus 1′ in accordance with the second embodiment is embodied as an absorption filter that is coordinated with the wavelength of the non-wavelength-converted laser light, such that it absorbs predominantly blue laser light. The absorption filter 4′ is embodied as a coating on the top side 32 of the light wavelength conversion element 3 and includes or essentially consists of glass which is substantially transparent to yellow light and is provided with dopants that primarily absorb short-wave light. A suitable dopant used is titanium oxide (TiO₂), for example, which principally absorbs light from the spectral range of blue light. Alternatively or additionally, cerium oxide (CeO₂) can also be used as dopant for this purpose.

FIG. 5 schematically illustrates, by means of a solid line, the layer thickness D4′ of the filter 4′ as a function of the distance from the center of the light-emitting surface at the top side 32 of the light wavelength conversion element 3. The layer thickness D in percent relative to a maximum value D′ₘₐₓ of the layer thickness D4′ of the filter 4′ is plotted on the vertical axis, and the distance A from the center of the light-emitting surface at the top side 32 of the light wavelength conversion element 3 in millimeters is plotted on the horizontal axis. The layer thickness D4′ of the filter 4′ proceeding from a maximum value D′ₘₐₓ, which is attained in the center of the light-emitting surface on the top side 32 of the circular-disk-shaped light wavelength conversion element 3, decreases in a radial direction down to the value 0, which is attained at the edge of the light wavelength conversion element 3. The layer thickness D4′ of the filter 4′ is indicated in percent in FIG. 5, wherein the maximum value D′ₘₐₓ of the layer thickness serves as a reference. The layer thickness D4′ is 100% of the maximum value D′ₘₐₓ in the center of the top side 32 and 0% of the maximum value D′ₘₐₓ at the edge. The laser beam 20 emitted by the laser diode device 2 is directed at the center of the underside 31 of the light wavelength conversion element 3 and penetrates through the light wavelength conversion element 3. The laser beam is scattered and proportionally wavelength-converted light is generated. The layer thickness D4′ of the filter 4′ is embodied in such a way that the top side 32 of the light wavelength conversion element 3 together with the filter 4′ emits everywhere light whose color coordinates are coordinated with that color locus of the light emitted by the top side 32 of the light wavelength conversion element 3 which has the highest yellow proportion. The light color of the light emitted by the light wavelength conversion element 3 is substantially homogeneous over the top side 32 of the light wavelength conversion element 3 provided with the filter 4′.

The maximum value D′ₘₐₓ of the layer thickness D4′ of the filter 4′ is dependent on the desired absorptance of the filter 4′ and is at a value in the value range of 1 micrometer to 10 millimeters and e.g. at a value in the value range of 10 micrometers to 1 millimeter. The absorption of the filter 4′ follows the Lambert-Beer law. Accordingly, the intensity of the blue laser light in the filter layer decreases exponentially with the layer thickness of the filter 4′. The wavelength-converted light is hardly absorbed or not absorbed at all.

The absorption filter 4′ illustrated schematically in FIG. 5 can be constructed from a plurality of layers of different thicknesses and extents that are successively applied to the top side 32 of the light wavelength conversion element 3.

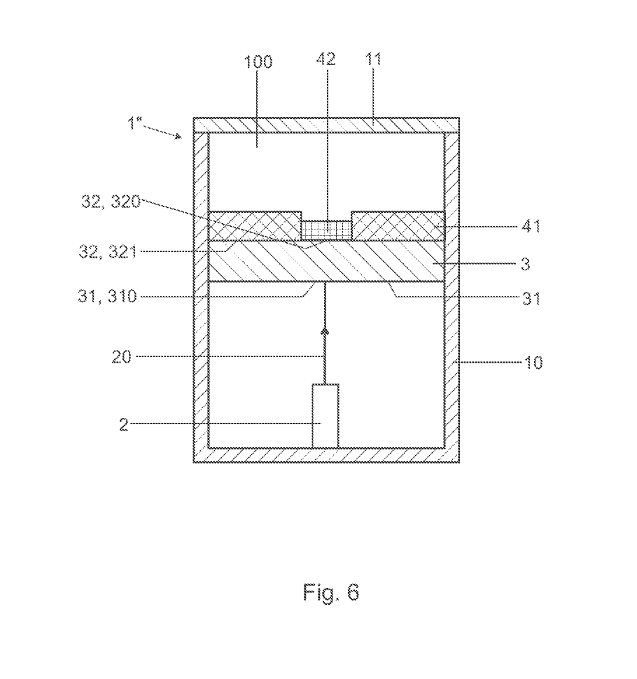

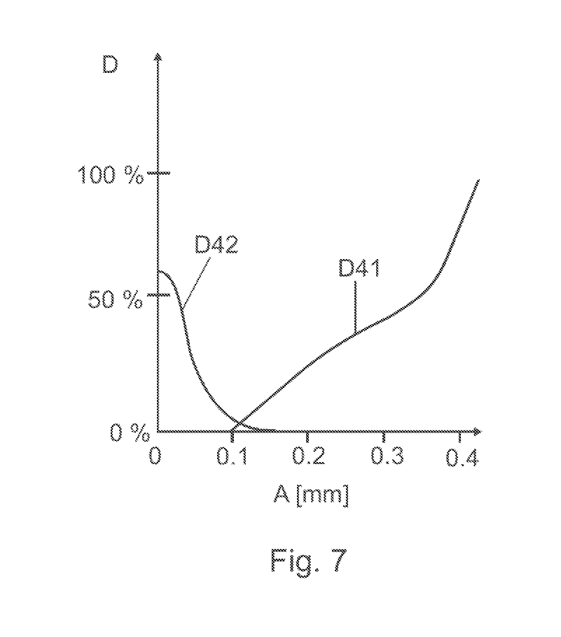

FIG. 6 and FIG. 7 schematically illustrate a lighting apparatus in accordance with the third embodiment. The lighting apparatus in accordance with the third embodiment differs from the above-described lighting apparatus in accordance with the first embodiment only in the different embodiment of the filter 4″. The lighting apparatuses in accordance with the first and third embodiments correspond in all other details. Therefore, in FIG. 1 and FIG. 6 identical components of the lighting apparatuses are designated by the same reference signs and, for the description thereof, reference is made to the description of the first embodiment of the lighting apparatus according to various embodiments.

The lighting apparatus 1″ in accordance with the third embodiment has a cylindrical housing 10 having a light exit opening 100, which is formed by a transparent housing wall or transparent cover 11 at an end side of the housing 10, a laser diode device 2 arranged within the housing 10, and a light wavelength conversion element 3 and also two filters 41, 42. The proportions of the individual components of said lighting apparatus 1″ are not illustrated in a manner true to scale in FIG. 6.

Two different absorption filters 41, 42 are applied as a coating on the top side 32 of the light wavelength conversion element 3.

The first filter 41 is embodied as an annular coating of the edge region 321 of the top side 32 of the light wavelength conversion element 3 and includes or essentially consists of glass provided with dopants that serve for the absorption of wavelength-converted light. By way of example, cobalt oxide (CoO) serves as a dopant. The layer thickness D41 of the first filter 41 decreases from a maximum value D41ₘₐₓ, which is attained at the edge of the circular-disk-shaped light wavelength conversion element 3, in a radial direction toward the center, irradiated with laser light, to the minimum value 0.

The second filter 42 is embodied as a circular-disk-shaped coating of the central region 320 of the top side 32 of the light wavelength conversion element 3, and consists of glass provided with dopants that serve for the absorption of blue laser light. By way of example, titanium oxide (TiO₂) serves as a dopant. The layer thickness of the second filter 42 decreases proceeding from a maximum value D42ₘₐₓ, which is attained in the center of the light-emitting surface on the top side 32 of the circular-disk-shaped light wavelength conversion element 3, in a radial direction to the edge down to the value 0. In this embodiment, the maximum value D42ₘₐₓ of the layer thickness D42 of the second filter 42 corresponds to 75% of the maximum value of the layer thickness D41 of the first filter 41.

In FIG. 7, the layer thickness D of the filters 41, 42 is illustrated in percent and as a function of the distance A from the center of the light-emitting surface at the top side 32 of the light wavelength conversion element 3 in millimeters, wherein the maximum value D41ₘₐₓ of the layer thickness of the first filter 41 serves as a reference for the layer thicknesses of both filters 41, 42 and is designated by 100%. The layer thickness profile of the filters 41, 42 is not illustrated in FIG. 6.

At the edge of the top side 32 of the light wavelength conversion element 3, the layer thickness D41 of the first filter 41 is 100% of the maximum value D41ₘₐₓ and decreases in a radial direction to the center to the value 0%. The layer thickness D42 of the second filter 42 is 0% at the edge of the top side 32 of the light wavelength conversion element 3 and increases in a radial direction to the center to the maximum value 75%.

In an annular region at a small distance from the center of the top side 32, both filters 41, 42 can overlap on the top side 32 of the light wavelength conversion element 3.

The laser beam 20 emitted by the laser diode 2 is directed at the center of the underside 31 of the light wavelength conversion element 3 and penetrates through the light wavelength conversion element 3. The laser beam is scattered and proportionally wavelength-converted light is generated. The layer thicknesses of the filters 41, 42 are embodied in such a way that the top side 32 of the light wavelength conversion element 3 together with the filters 41, 42 emits light whose color coordinates have the values x=0.32 and y=0.34 in the CIE standard chromaticity diagram according to CIE 1931. The light color of the light emitted by the light wavelength conversion element 3 is substantially homogeneous over the top side 32 of the light wavelength conversion element 3 provided with the filters 41, 42. It corresponds to white light which, on account of the filters 41, 42, is an almost homogeneous mixture of non-wavelength-converted blue laser light and light wavelength-converted at the light wavelength conversion element 3.

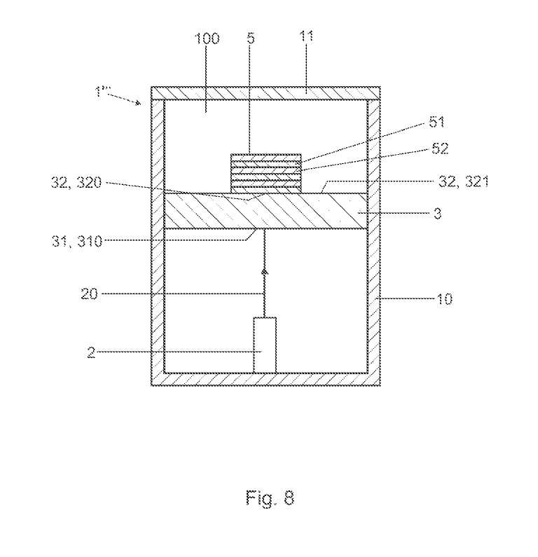

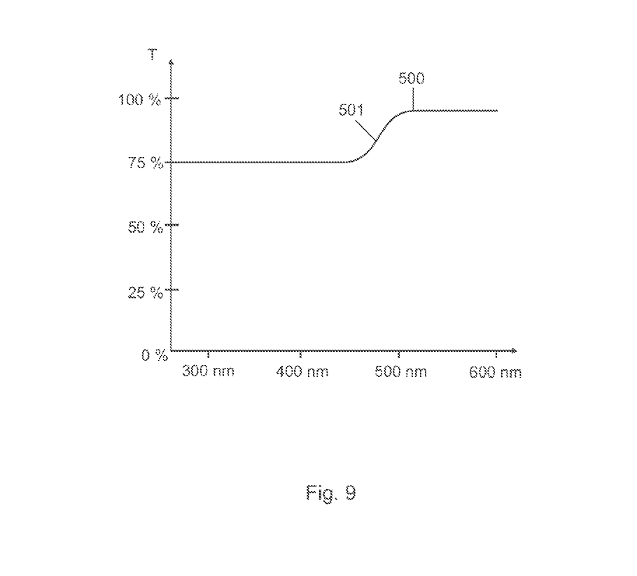

FIG. 8 and FIG. 9 schematically illustrate a lighting apparatus 1′″ in accordance with the fourth embodiment. The lighting apparatus in accordance with the fourth embodiment differs from the above-described lighting apparatus in accordance with the first embodiment only in the different embodiment of the filter 5. The lighting apparatuses in accordance with the first and fourth embodiments correspond in all other details. Therefore, in FIGS. 1 and 8 identical components of the lighting apparatuses 1, 1′ are designated by the same reference signs and, for the description thereof, reference is made to the description of the first embodiment of the lighting apparatus according to various embodiments.

The lighting apparatus 1′″ in accordance with the fourth embodiment has a cylindrical housing 10 having a light exit opening 100, which is formed by a transparent housing wall or transparent cover 11 at an end side of the housing 10, a laser diode device 2 arranged within the housing 10, and a light wavelength conversion element 3 and also a filter 5. The proportions of the individual components of said lighting apparatus 1′″ are not illustrated in a manner true to scale in FIG. 8.

An interference filter 5 is applied as a coating on the top side 32 of the light wavelength conversion element 3. The interference filter 5 is arranged only in a central region 320 on the top side 32 of the light wavelength conversion element 3. An edge region 321 of the top side 32 of the light wavelength conversion element 3 is embodied without filter 5. The interference filter 5 consists of alternating optically low refractive index layers 51 and optically high refractive index layers 52. The optically low refractive index layers 51 consist for example of silicon oxide (SiO₂) and the optically high refractive index layers 52 of titanium oxide (TiO₂). The layer thickness and number of said layers 51, 52 is implemented for example in such a way that the transmission curve 500 of the filter 5 (FIG. 9) has a filter edge 501 in the wavelength range of approximately 470 nanometers to 500 nanometers, which lies above the wavelength of the blue laser light 20, and has a high transmission for light having wavelengths greater than the wavelength of the filter edge and a low transmission for light having wavelengths less than the wavelength of the filter edge. FIG. 9 schematically illustrates on the vertical axis the transparency T of the filter 5 in percent as a function of the wavelength of the light impinging on the filter 5. The percentage value relates to the intensity of the light impinging on the filter 5. By way of example, the value T=100% means that 100% of the impinging light is transmitted by the filter 5. The interference filter 5 attenuates the intensity of the laser radiation 20 which is directed centrally at the underside 31 of the light wavelength conversion element 3 and penetrates through the light wavelength conversion element 3, in the central region 320 of the light-emitting top side 32 of the light wavelength conversion element 3. As a result, the blue proportion of the light emitted by the top side 32 of the light wavelength conversion element 3 is correspondingly reduced in the central region 320 of the top side 32, while the wavelength-converted proportion of the light emitted by the top side 32 passes through the filter 5 almost without attenuation. No attenuation of the blue proportion of the light emitted by the top side 32 of the light wavelength conversion element 3 takes place in the edge region 321 of the top side 32 of the light wavelength conversion element 3, which edge region is embodied without a filter 5. Overall, this results in a more homogeneous distribution of the proportions of non-wavelength-converted laser light and light wavelength-converted in the light wavelength conversion element 3 and thus a more homogeneous distribution of the light color over the light-emitting top side 32 of the light wavelength conversion element 3.

By altering the layer design of the interference filter 5, it is possible to alter the transmission curve 500 and, in particular, the position and steepness of the filter edge 501, such that a higher or lower proportion of the laser light 20 can pass through the filter 5. Accordingly, it is possible to vary the proportion of the non-wavelength-converted laser light in the light emitted by the top side 32 of the light wavelength conversion element 3.

The interference filter 5 can furthermore be combined with an absorption filter, in order for example to reduce the dependence of the filter effect of the interference filter 5 on the angle of incidence of the light on the filter 5.

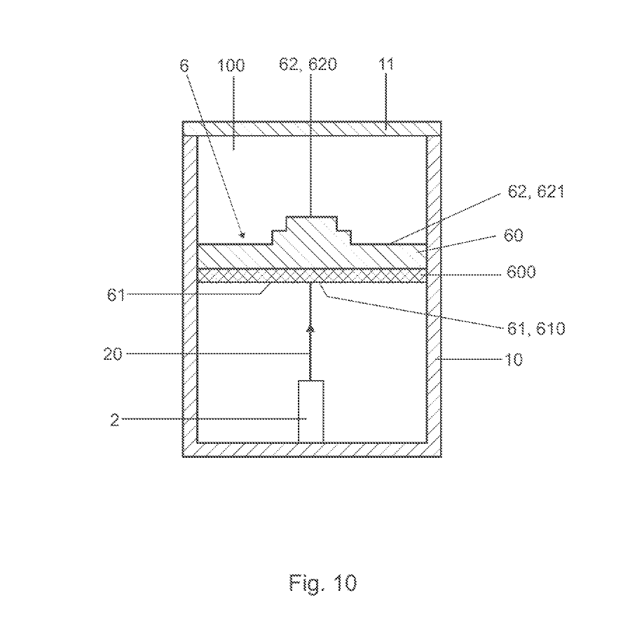

FIG. 10 schematically illustrates a lighting apparatus in accordance with the fifth embodiment. The lighting apparatus in accordance with the fifth embodiment has a cylindrical housing 10 having a light exit opening 100, which is formed by a transparent housing wall or transparent cover 11 at an end side of the housing 10, and a laser diode device 2 arranged within the housing 10, and also a light wavelength conversion element 6. The proportions of the individual components of said lighting apparatus 1 are not illustrated in a manner true to scale in FIG. 10. The housing 10, the light exit opening 100, the transparent cover 11 and the laser diode device 2 are embodied identically to the corresponding components of the lighting apparatus in accordance with the first embodiment. Therefore, in FIG. 1 and FIG. 10, the same reference signs are used for identical components and, for the description thereof, reference is made to the description of the lighting apparatus in accordance with the first embodiment.

The light wavelength conversion element 6 consists of cerium-doped yttrium aluminum garnet (YAG:Ce) 60 and a transparent substrate 600, for example sapphire. It is embodied as a circular disk having a diameter of 0.8 mm. The light wavelength conversion element 6 is arranged within the housing 10 between the laser diode device 2 and the light exit opening 100, such that laser light 20 emitted by the laser diode device 2 impinges centrally on an underside 61 of the circular-disk-shaped light wavelength conversion element 6, said underside facing away from the light exit opening 100. A central surface region 610 of the underside 61 of the light wavelength conversion element 6 is illuminated with laser light 20 from the laser diode device 2. A central surface region 620 at a top side 62 of the light wavelength conversion element 6, said top side facing the light exit opening 100, corresponds to the central surface region 610 at the underside 61 of the light wavelength conversion element 6. The laser light 20 impinging on the underside 61 in the central surface region 610 penetrates through the light wavelength conversion element 6 and in the process is converted proportionally into light of other wavelengths with an intensity maximum in the wavelength range of 560 nanometers to 590 nanometers, which corresponds to the spectral range of yellow light, such that at the top side 62 of the light wavelength conversion element 6 light emerges which is a mixture of non-wavelength-converted blue laser light and wavelength-converted light.

In the central region 620 on the top side 62 of the circular-disk-shaped light wavelength conversion element 6, the layer 60 composed of cerium-doped yttrium aluminum garnet (YAG:Ce) on the substrate 600 is thicker than in the edge region 621 of the top side 62. The layer thickness change of the layer 60 is merely illustrated schematically in FIG. 10. The layer thickness profile can in particular also be continuous instead of stepped.

The laser beam 20 emitted by the laser diode device 2 is directed at the center of the underside 61 of the light wavelength conversion element 6 and penetrates through the light wavelength conversion element 6. The laser light is scattered and proportionally wavelength-converted light is generated. The thickness of the layer 60 composed of cerium-doped yttrium aluminum garnet (YAG:Ce) on the substrate 600 is embodied in such a way that the light emitted by the central surface region 620 of the top side 62 of the light wavelength conversion element 6 contains the same proportions of non-wavelength-converted laser light and wavelength-converted light as the light emitted by the edge region 621 of the top side 62 of the light wavelength conversion element 6 and a homogeneous light color of the light emitted by the top side 62 is thus ensured.

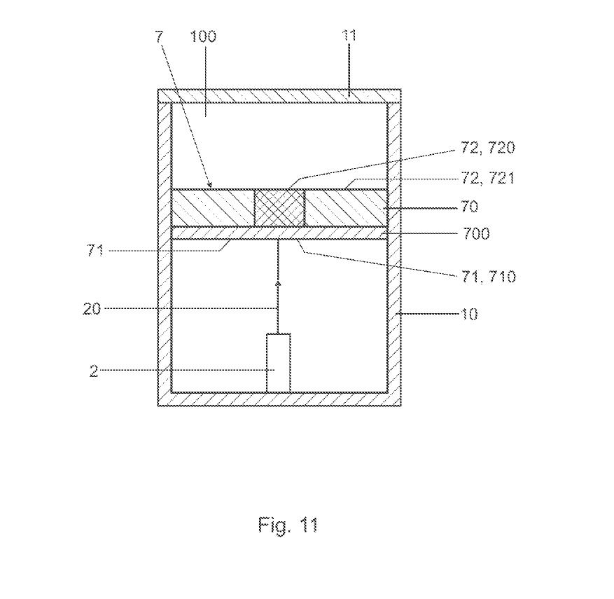

FIG. 11 schematically illustrates a lighting apparatus in accordance with the sixth embodiment. The lighting apparatus in accordance with the sixth embodiment differs from the above-described lighting apparatus in accordance with the fifth embodiment only in the different embodiment of the light wavelength conversion element 7. The lighting apparatuses in accordance with the fifth and sixth embodiments correspond in all other details. Therefore, in FIGS. 10 and 11 identical components of the lighting apparatuses are designated by the same reference signs and, for the description thereof, reference is made to the description of the fifth embodiment apparatus according to various embodiments.

The light wavelength conversion element 7 consists of a transparent substrate 700, for example sapphire, with—arranged thereon—a coating 70 composed of cerium-doped yttrium aluminum garnet (YAG:Ce). It is embodied as a circular disk having a diameter of 0.8 mm. The light wavelength conversion element 7 is arranged within the housing 10 between the laser diode device 2 and the light exit opening 100, such that laser light 20 emitted by the laser diode 2 impinges centrally on an underside 71 of the circular-disk-shaped light wavelength conversion element 7, said underside facing away from the light exit opening 100. A central surface region 710 of the underside 71 of the light wavelength conversion element 7 is illuminated with laser light 20 from the laser diode device 2. A central surface region 720 at a top side 72 of the light wavelength conversion element 7, said top side facing the light exit opening 100, corresponds to the central surface region 710 at the underside 71 of the light wavelength conversion element 7. The laser light 20 impinging on the underside 71 in the central surface region 710 penetrates through the light wavelength conversion element 7 and in the process is converted proportionally into light of other wavelengths with an intensity maximum in the wavelength range of 560 nanometers to 590 nanometers, which corresponds to the spectral range of yellow light, such that at the top side 72 of the light wavelength conversion element 7 light emerges which is a mixture of non-wavelength-converted blue laser light and wavelength-converted light.

In the central region 720 on the top side 72 of the circular-disk-shaped light wavelength conversion element 7, the layer 70 composed of cerium-doped yttrium aluminum garnet (YAG:Ce) on the substrate 700 has a higher concentration of cerium than in the edge region 721 at the top side 72 of the light wavelength conversion element 7. The change in the cerium concentration from the central region 720 in the direction of the edge region 721 can be continuous, for example.

The concentration of the phosphor cerium in the layer 70 composed of cerium-doped yttrium aluminum garnet (YAG:Ce) on the substrate 700 is embodied in such a way that the light emitted by the central surface region 720 of the top side 72 of the light wavelength conversion element 7 contains the same proportions of non-wavelength-converted laser light and wavelength-converted light as the light emitted by the edge region 721 of the top side 72 of the light wavelength conversion element 7 and a homogeneous light color of the light emitted by the top side 72 is thus ensured.

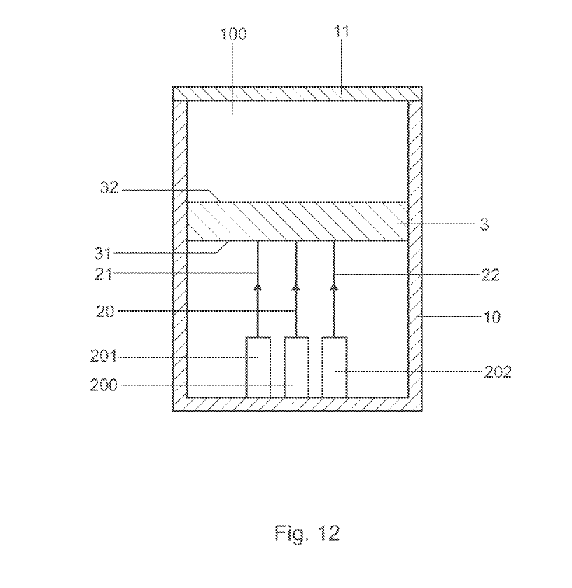

FIG. 12 schematically illustrates a lighting apparatus in accordance with the seventh embodiment.

The lighting apparatus in accordance with the seventh embodiment has a cylindrical housing 10 having a light exit opening 100, which is formed by a transparent housing wall or transparent cover 11 at an end side of the housing 10, and nine laser diode devices 200, 201, 202 arranged within the housing 10, and also a light wavelength conversion element 3. The proportions of the individual components of said lighting apparatus 1 are not illustrated in a manner true to scale in FIG. 12. The housing 10, the light exit opening 100, the transparent cover 11 and the light wavelength conversion element 3 are embodied identically to the corresponding components of the lighting apparatus in accordance with the first embodiment. Therefore, in FIG. 1 and FIG. 10, the same reference signs are used for identical components and, for the description thereof, reference is made to the description of the lighting apparatus in accordance with the first embodiment.

The lighting apparatus in accordance with the seventh embodiment has nine laser diode devices 200, 201, 202 arranged in three rows and three lines alongside one another within the housing 10. Only three of the nine laser diode devices are depicted in FIG. 12. The laser diode devices each consist of a laser diode and a downstream optical unit for shaping the laser beam profile of the respective laser diode. The nine laser diode devices 200, 201, 202 each irradiate the underside 31 of the light wavelength conversion element 3 with blue laser light 20, 21, 22, which penetrates through the light wavelength conversion element 3 and in the process is scattered and converted proportionally into light of other wavelengths with an intensity maximum in the wavelength range of 560 nanometers to 590 nanometers, such that the top side 32 of the light wavelength conversion element 3 emits light which is a mixture of non-converted laser light and light wavelength-converted in the light wavelength conversion element 3. The distances between the nine laser diode devices 200, 201, 202 are set in such a way that the top side 32 of the light wavelength conversion element 3 emits light which, along the top side 32, contains identical proportions of non-wavelength-converted laser light and thus has a homogeneous light color. In various embodiments, the distances between the laser diode devices 200, 201, 202 are coordinated with the profile and the intensity of the laser beams emitted by the laser diode devices 200, 201, 202, and also with the degree of expansion of the laser beams as a result of light scattering in the light wavelength conversion element 3. By way of example, in the case of non-rotationally symmetrical laser beam profiles, the line distances between the laser diode devices 200, 201, 202 arranged in a matrixlike fashion can be different than the column distances between the laser diode devices 200, 201, 202.

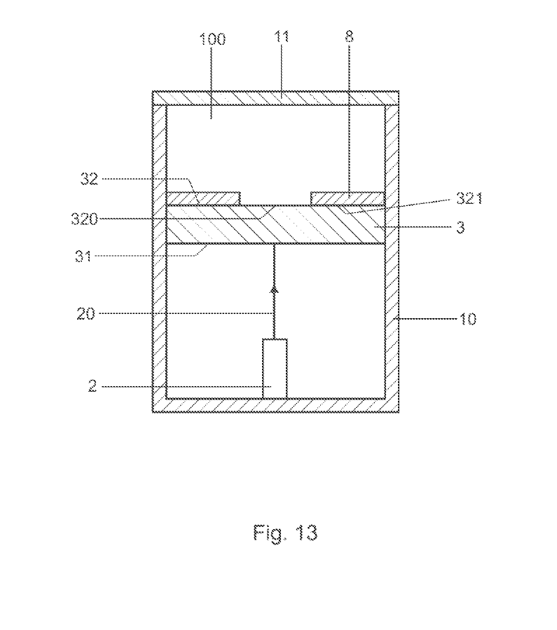

FIG. 13 schematically illustrates a lighting apparatus in accordance with the eighth embodiment. The lighting apparatus in accordance with the eighth embodiment differs from the above-described lighting apparatus in accordance with the first embodiment only in that, instead of the filter 4, a heat-reflecting coating 8 is provided on the light wavelength conversion element 3. The lighting apparatuses in accordance with the first and eighth embodiments correspond in all other details. Therefore, in FIG. 1 and FIG. 13 identical components of the lighting apparatuses are designated by the same reference signs and, for the description thereof, reference is made to the description of the first embodiment of the lighting apparatus according to various embodiments.

The lighting apparatus in accordance with the eighth embodiment has a cylindrical housing 10 having a light exit opening 100, which is formed by a transparent housing wall or transparent cover 11 at an end side of the housing 10, a laser diode device 2 arranged within the housing 10, and a light wavelength conversion element 3 and also a heat-reflecting coating 8. The proportions of the individual components of said lighting apparatus are not illustrated in a manner true to scale in FIG. 13.

The housing 10, including light exit opening 100 and transparent cover 11, and also the laser diode device 2 and the light wavelength conversion element 3 are embodied identically to the lighting apparatus in accordance with the first embodiment. For the description thereof, reference is made to the description of these components of the first embodiment.

The light wavelength conversion element 3 is provided with a transparent, heat-reflecting coating 8 on its top side 32 facing the light exit opening 100 and facing away from the laser diode device 2. The coating 8 is embodied as an ITO layer and extends only over an annular edge region 321 of the top side 32. A central region 320 of the top side 32 is embodied without a coating 8. The coating 8 includes or essentially consists of indium tin oxide. The coating 8 reflects infrared radiation, which arises for example as a result of the illumination of the light wavelength conversion element 3 with laser light 20 or the partial wavelength conversion of the laser light 20 in the light wavelength conversion element 3, back into the light wavelength conversion element 3 and thus contributes to an additional heating of the light wavelength conversion element 3. The proportion of the wavelength-converted light in the light emitted by the top side 32 of the light wavelength conversion element 3 is reduced as a result of the additional heating of the light wavelength conversion element 3. In various embodiments, therefore, in surface regions 321 of the light-emitting top side 32 of the light wavelength conversion element which are situated near the edge of the light wavelength conversion element 3, the yellow proportion of the light emitted by said surface regions 321 is reduced and a better color homogenization of the light emitted by the light wavelength conversion element 3 is thus effected.

The embodiments are not restricted to the embodiments explained in greater detail above.

By way of example, the laser diode device 2 in the embodiments described above may include a plurality of laser diodes and a common optical unit or separate optical units for shaping the profile of a laser beam of the laser diode device 2. In various embodiments, the laser beams from a plurality of laser diodes of the laser diode device 2 can be combined to form a common beam of laser light of the laser diode device 2.

Moreover, the shape of the coatings embodied as absorption filters or interference filters on the at least one light wavelength conversion element in the case of the embodiments illustrated in FIG. 1 to FIG. 9 can be coordinated with the shape of the profile of the beam 20 of laser light emitted by the laser diode device 2. In various embodiments, the shape of said coatings on the at least one light wavelength conversion element need not be embodied as annular or circular-disk-shaped, but rather can likewise have an elliptical symmetry for example in the case of an elliptical profile of the beam 20 of laser light on the at least one light wavelength conversion element.

Analogously, the shape or geometry of the layer thickness change of the light wavelength conversion element and the change or a gradient of the phosphor concentration in the light wavelength conversion element in the case of the embodiments illustrated in FIG. 10 and FIG. 11 can be adapted to the profile of the beam 20 of laser light.

Furthermore, by way of example, the interference filter 5 of the embodiment depicted in FIG. 8 and FIG. 9 can also be embodied in such a way that it primarily attenuates wavelength-converted light.

Moreover, the heat-reflecting coating 8 in accordance with the embodiment illustrated in FIG. 13 can also additionally be used in the lighting apparatuses in accordance with the other embodiments.

Furthermore, the lighting apparatuses in accordance with the embodiments illustrated in FIG. 1 to FIG. 11 and FIG. 13 can in each case also have a plurality of laser diode devices 2, or laser diodes, which generate a common luminous spot or a plurality of separate, mutually overlapping or non-overlapping luminous spots on the at least one light wavelength conversion element, and the filters, with regard to their layer thickness, their geometry and their spatial arrangement, can be coordinated with the arrangement of the laser diode devices and the intensity of the laser light generated by the laser diode devices.

Furthermore, in the case of the embodiment of the lighting apparatus according to various embodiments as illustrated in FIG. 12, the number of laser diode devices 200, 201, 202 can be different than nine. Moreover, instead of the matrixlike arrangement, the laser diode devices 200, 201, 202 can for example also have a linear arrangement or an arrangement in one annulus or in a plurality of concentric annuli or in one ellipse or in a plurality of concentric ellipses. A linear arrangement of the laser diode devices is advantageous, for example, for applications of the lighting apparatus in scanners. The laser diode devices can furthermore be arranged and embodied in such a way that the luminous spots generated by them on the light wavelength conversion element overlap.

In addition to the laser diode devices or as replacement for some of the laser diode devices 200, 201, 202, the lighting apparatus in accordance with the embodiment as illustrated in FIG. 12 can also have other light sources, for example light-emitting diodes, which illuminate the at least one light wavelength conversion element with light having a wavelength similar to that for the at least one laser diode device 2.

Furthermore, the invention is not restricted to the configuration of the light wavelength conversion elements of the lighting apparatus according to various embodiments as illustrated in FIG. 1 to FIG. 13. By way of example, instead of a circular-disk-shaped configuration, the light wavelength conversion element can also have some other geometry and other dimensions; by way of example, it can have a square or rectangular or elliptical contour or any other geometry. It can likewise also have other dimensions. In various embodiments, the shape and the dimensions of the at least one light wavelength conversion element will be adapted to the arrangement and number of the laser light sources and also to the desired application. The at least one light wavelength conversion element may include, as disclosed in the embodiments explained above, a transparent substrate consisting of sapphire, for example, with cerium-doped yttrium aluminum garnet arranged thereon. Alternatively, the at least one light wavelength conversion element can also include a cerium-doped yttrium aluminum garnet ceramic.

Moreover, the embodiments are not restricted to lighting apparatuses including one or a plurality of light-transmissive light wavelength conversion elements. Instead, the lighting apparatus according to various embodiments can also have one or a plurality of light wavelength conversion elements embodied in a light-reflecting fashion. In this case, the at least one light wavelength conversion element can have, for example, a substrate embodied in a light-reflecting fashion, cerium-doped yttrium aluminum garnet, for example, being arranged on said substrate. In this case, the at least one laser light source is arranged in such a way that its laser light impinges at an angle of incidence that differs from zero degrees on the surface of the light-reflecting substrate provided with cerium-doped yttrium aluminum garnet, such that it leaves the cerium-doped yttrium aluminum garnet again after proportional wavelength conversion and reflection at the light-reflecting substrate as white light which is a mixture of non-wavelength-converted blue laser light and wavelength-converted light. In this case, the light-emitting surface of the at least one light wavelength conversion element is identical to that surface of the at least one light wavelength conversion element which is irradiated with laser light.

Various embodiments provide a lighting apparatus of the generic type which emits, across a defined, local region, light which includes a mixture of non-wavelength-converted laser light and light wavelength-converted at the light wavelength conversion element, which mixture is as homogeneous as possible in terms of color.

The lighting apparatus according to various embodiments has at least one laser light source, e.g. in the form of an arrangement of one or a plurality of laser diodes, and at least one light wavelength conversion element for the wavelength conversion of laser light emitted by the at least one laser light source. In addition, the lighting apparatus according to various embodiments has means for homogenizing the light color of the light emitted by it. What is achieved as a result is that the lighting apparatus according to various embodiments emits light having a light color that is as homogeneous as possible.

The abovementioned means of the lighting apparatus according to various embodiments for homogenizing the light color may be configured in such a way that the light emitted by a light-emitting surface or by a light-emitting surface section of the at least one light wavelength conversion element is a mixture of non-wavelength-converted laser light and light wavelength-converted by the light wavelength conversion element, which mixture is as homogeneous as possible in terms of color.

By way of example, the abovementioned means of the lighting apparatus according to various embodiments include at least one color filter. The relative proportions of non-wavelength-converted laser light and wavelength-converted light are altered with the aid of the at least one color filter, such that light emitted by a light-emitting surface or a light-emitting surface section of the at least one light wavelength conversion element of the lighting apparatus according to various embodiments has a more homogeneous light color.

By way of example, a filter effect of the at least one color filter of the lighting apparatus according to various embodiments is coordinated with a wavelength or a wavelength range of the laser light emitted by the at least one laser light source or of the light wavelength-converted by the at least one light wavelength conversion element. The filter effect of the at least one color filter can also be coordinated with a wavelength or a wavelength range of the laser light emitted by the at least one laser light source and of the light wavelength-converted by the light wavelength conversion element. As a result, the proportion of the non-wavelength-converted laser light or the proportion of the wavelength-converted light or both aforementioned proportions in the light emitted by a light-emitting surface or a light-emitting surface section of the at least one light wavelength conversion element of the lighting apparatus according to various embodiments can be reduced such that the color homogeneity of the light emitted by the light-emitting surface or the light-emitting surface section of the at least one light wavelength conversion element and thus also the color homogeneity of the light emitted by the lighting apparatus according to various embodiments is improved.

In accordance with one or a plurality of various embodiments, the at least one color filter is embodied as a dichroic filter, in particular as an interference filter. As a result, the filter effect is achieved by means of destructive interference between a multiplicity of filter layers having alternately high and low optical refractive indexes. Dichroic filters may have the effect that their filter effect can be coordinated with the wavelength of the laser light and/or of the wavelength-converted light by adaptation of the layer design and of the layer thicknesses of the individual filter layers. In various embodiments, it is thereby possible for a filter edge of the dichroic filter, which filter edge defines the transition of the dichroic filter from the light wavelength range with high transmittance of the filter to the light wavelength range with low transmittance of the filter, to be set to a desired wavelength. In addition, the steepness of the filter edge can also be set by varying the number of layers of the dichroic filter. Moreover, it is also possible to provide two or more dichroic filters having different filter edges in order to achieve a color homogenization of the light emitted by the lighting apparatus according to various embodiments.

The at least one dichroic color filter may be embodied as a coating on a surface of the at least one light wavelength conversion element. As a result, the filter effect can be restricted to a selected region of the surface of the light wavelength conversion element. In various embodiments, the dichroic color filter is arranged on a light-emitting surface or a light-emitting surface section of the at least one light wavelength conversion element. Additionally or alternatively, the dichroic color filter can also be arranged on a surface irradiated with laser light, or a surface section irradiated with laser light, of the at least one light wavelength conversion element. Alternatively, the at least one dichroic color filter can furthermore also be arranged on a light-transmissive carrier arranged separately from the light wavelength conversion element.

In accordance with one or a plurality of further embodiments, the at least one color filter is embodied as an absorption filter. As a result, the filter effect is achieved by means of absorption of non-wavelength-converted laser light or of wavelength-converted light. In this case, the absorptance can be set to a desired value with the aid of a thickness of the filter. Through a suitable choice of absorber, the absorption filter can be coordinated with the wavelength of the non-wavelength-converted laser light or of the light wavelength-converted by the light wavelength conversion element.

In various embodiments, the absorption filter is arranged as a coating on a surface of the at least one light wavelength conversion element. As a result, no additional mount is required for the absorption filter and the absorption filter can be embodied as a structural unit with the light wavelength conversion element.

In various embodiments, the absorption filter is arranged as a coating on a light-emitting surface or a light-emitting surface section of the at least one light wavelength conversion element. Alternatively or additionally, however, the absorption filter can also be arranged on a surface irradiated with laser light, or a surface section irradiated with laser light, of the at least one light wavelength conversion element.

In various embodiments, the layer thickness of the coating is embodied such that it is locally different. As a result, the absorptance of the absorption filter can be made locally different over the coated surface or the coated surface section of the at least one light wavelength conversion element, in order to reduce even further an inhomogeneity of the color distribution of the light emitted by the light-emitting surface or the light-emitting surface section of the at least one light wavelength conversion element.

The layer thickness or/and the shape of the coating may be coordinated with a shape of a luminous spot generated by the at least one laser light source on the at least one light wavelength conversion element or with a profile of the laser light generated by the at least one laser light source, in order to obtain a further improvement in the color homogeneity of the light or mixed light emitted by the at least one light wavelength conversion element. By way of example, the coating has an elliptical contour in the case of an elliptical profile of the laser light beam or in the case of a luminous spot having an elliptical contour on the at least one light wavelength conversion element.

In accordance with one or a plurality of various embodiments, the absorption filter of the lighting apparatus according to various embodiments is configured in such a way that it may absorb light having the wavelength of the laser light from the at least one laser light source, in order to reduce the proportion of the non-wavelength-converted laser light in the light emitted by the light-emitting surface or by the light-emitting surface section of the at least one light wavelength conversion element of the lighting apparatus according to various embodiments and, as a result, to improve the homogeneity of the light color of the light emitted by the lighting apparatus according to various embodiments.

In various embodiments, the layer thickness of the absorption filter in regions of the coated surface of the at least one light wavelength conversion element which are at a comparatively small distance from an impingement location of the laser light on the at least one light wavelength conversion element is greater than that in regions of the coated surface of the at least one light wavelength conversion element which are at a larger distance from an impingement location of the laser light on the at least one light wavelength conversion element, in order that non-wavelength-converted laser light emitted by the light-emitting surface of the at least one light wavelength conversion element, said laser light being emitted from surface regions near an impingement location of the laser light on the at least one light wavelength conversion element, is absorbed to a greater extent than non-wavelength-converted laser light emitted from surface regions which are at a larger distance from an impingement location of the laser light on the at least one light wavelength conversion element. As a result, in each case the proportions of the non-wavelength-converted laser light and of the wavelength-converted light in the light emitted from regions of the light-emitting surface of the at least one light wavelength conversion element at different distances from an impingement location of the laser light on the at least one light wavelength conversion element are adapted and the homogeneity of the light color of the light emitted by the light-emitting surface or the light-emitting surface section of the at least one light wavelength conversion element of the light wavelength conversion element according to various embodiments is thus improved further.

In accordance with one or a plurality of embodiments, the absorption filter is configured in such a way that it may absorb light having a wavelength of the light wavelength-converted by the light wavelength conversion element, in order to reduce the proportion of the wavelength-converted light in the light emitted by a light-emitting surface or a light-emitting surface section of the at least one light wavelength conversion element of the lighting apparatus according to various embodiments and thereby to improve the homogeneity of the light color of the light emitted by the lighting apparatus according to various embodiments.

In various embodiments, the layer thickness of the absorption filter in regions of the coated surface of the at least one light wavelength conversion element which are at a comparatively large distance from an impingement location of the laser light on the at least one light wavelength conversion element is greater than that in regions of the coated surface of the at least one light wavelength conversion element which are at a smaller distance from an impingement location of the laser light on the at least one light wavelength conversion element, in order that wavelength-converted light emitted by the light-emitting surface of the at least one light wavelength conversion element, said light being emitted from regions of the light-emitting surface of the at least one light wavelength conversion element at a comparatively large distance from an impingement location of the laser light on the at least one light wavelength conversion element, is absorbed to a greater extent than wavelength-converted light emitted from regions of the light-emitting surface of the at least one light wavelength conversion element which are at a comparatively smaller distance from an impingement location of the laser light on the at least one light wavelength conversion element. As a result, in each case the proportions of the wavelength-converted light and of the non-wavelength-converted laser light in the light emitted from regions of the light-emitting surface of the at least one light wavelength conversion element at different distances from an impingement location of the laser light on the at least one light wavelength conversion element are adapted and the homogeneity of the light color of the light emitted by the light wavelength conversion element according to various embodiments is thus improved further.

As an alternative or in addition to the at least one color filter, the means for homogenizing the light color of the light emitted by the lighting apparatus may include phosphor contained in the at least one light wavelength conversion element, wherein a thickness of the at least one light wavelength conversion element or a concentration of the phosphor in the at least one light wavelength conversion element may be embodied such that it is locally different, in order that the relative proportions of non-wavelength-converted laser light and wavelength-converted light which are emitted from different regions of the light-emitting surface of the at least one light wavelength conversion element are adapted to one another. By way of example, for this purpose, a thickness of the at least one light wavelength conversion element in regions of the at least one light wavelength conversion element which are irradiated with laser light can be larger than that in regions of the at least one light wavelength conversion element which are not directly irradiated with laser light, or a concentration of the phosphor in regions of the at least one light wavelength conversion element that are irradiated with high laser light intensity can be higher than that in regions of the at least one light wavelength conversion element which are not directly irradiated with laser light or are irradiated with low laser light intensity.

In various embodiments, a shape of a region of the at least one light wavelength conversion element having a locally different thickness of the at least one light wavelength conversion element or having a locally different concentration of the phosphor in the at least one light wavelength conversion element is coordinated with a shape or a color profile of a luminous spot generated by the at least one laser light source on the at least one light wavelength conversion element or with a profile of the laser light generated by the at least one laser light source, in order to further improve the color homogenization of the light emitted by the at least one light wavelength conversion element.

Alternatively or additionally, the means for homogenizing the light color of the light emitted by the lighting apparatus may include a thermal-radiation-reflecting coating of the light wavelength conversion element, which coating may be arranged on a surface section of the surface of the light wavelength conversion element, in order to exploit a temperature dependence of the efficiency of the wavelength conversion of the light wavelength conversion element and to reduce the proportion of wavelength-converted light in the coated region. By way of example, for this purpose, a surface of the at least one light wavelength conversion element may include a transparent indium tin oxide layer (ITO layer) or a light-transmissive gold layer.

Furthermore, the means for homogenizing the light color of the light emitted by the lighting apparatus may include illumination means configured in such a way that they illuminate the light wavelength conversion element with light having a wavelength the same as or similar to that of the laser light from the at least one laser light source, in order to enlarge the region of the light wavelength conversion element which is illuminated with non-wavelength-converted light. By way of example, the laser light emitted by the at least one laser light source can have a wavelength from the wavelength range of 440 to 460 nanometers and the light emitted by the illumination means can have a wavelength from the wavelength range of 400 to 500 nanometers.

In accordance with one or a plurality of preferred embodiments of the invention, the means for homogenizing the light color of the light emitted by the lighting apparatus according to various embodiments are embodied in such a way that the variation of the proportions of non-wavelength-converted laser light and light wavelength-converted by the at least one light wavelength conversion element in the light emitted by the at least one light wavelength conversion element over the light-emitting surface or the light-emitting surface section of the at least one light wavelength conversion element is reduced.

In various embodiments, the at least one laser light source and the at least one light wavelength conversion element of the lighting apparatus according to various embodiments are coordinated with one another in such a way that the lighting apparatus according to various embodiments emits white light which is a mixture of non-wavelength-converted laser light and light wavelength-converted by the at least one light wavelength conversion element. In various embodiments, the at least one laser light source and the at least one light wavelength conversion element of the lighting apparatus according to various embodiments are coordinated with one another in such a way that the lighting apparatus according to various embodiments emits white light which satisfies the legal regulations for motor vehicle headlights, in particular of the ECE standard ECE/324/Rev. 1/Adb.No. 48/Rev. 12.

The lighting apparatus according to various embodiments may be embodied as a motor vehicle headlight or as part of a motor vehicle headlight.

Moreover, the lighting apparatus according to various embodiments can also serve as a light source for other applications. By way of example, it can be used in projectors, spotlights, stage and architectural lighting and also in medical apparatuses and in microscopy and spectroscopy.

### LIST OF REFERENCE SIGNS

1,1′,1″,1′″ Lighting apparatus
2,200,201,202 Laser diode
3,6,7 Light wavelength conversion element
4,4′,5 Filter
10 Housing
11 Transparent cover
20,21,22 Laser beam
31,61,71 Underside of the light wavelength conversion element
32,62,72 Top side of the light wavelength conversion element
310,610,710 Central region of the underside
320,620,720 Central region at the top side of the light wavelength conversion element
321,621,721 Edge region at the top side of the light wavelength conversion element
100 Light exit opening
41 First filter
42 Second filter
51 Optically low refractive index layers
52 Optically high refractive index layers
500 Transmission curve
501 Filter edge
60,70 Layer composed of YAG:Ce
600,700 Substrate
D4,D4′,D41,D42 Layer thickness
8 Heat-reflecting coating

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A lighting apparatus, comprising:
at least one laser light source; and
at least one light wavelength conversion element for wavelength conversion of laser light from the at least one laser light source;
wherein the lighting apparatus has a structure configured to homogenize light color of the light emitted by the lighting apparatus.

2. The lighting apparatus of claim 1,
wherein the structure comprises at least one color filter.

3. The lighting apparatus of claim 2,
wherein a filter effect of the at least one color filter is coordinated with a wavelength or a wavelength range of the laser light emitted by the at least one laser light source or of the light wavelength-converted by the at least one light wavelength conversion element or with a wavelength or a wavelength range of the laser light emitted by the at least one laser light source and of the light wavelength-converted by the at least one light wavelength conversion element.

4. The lighting apparatus of claim 2,
wherein the at least one color filter is embodied as a dichroic filter.

5. The lighting apparatus of claim 2,
wherein the at least one filter is embodied as an absorption filter.

6. The lighting apparatus of claim 5,
wherein the absorption filter is arranged as a coating on a surface of the at least one light wavelength conversion element.

7. The lighting apparatus of claim 6,
wherein layer thickness of the coating is locally different.

8. The lighting apparatus of claim 6,
wherein at least one of layer thickness or shape of the coating is coordinated with a shape or a color profile of a luminous spot generated by the at least one laser light source on the at least one light wavelength conversion element or with a profile of the laser light generated by the at least one laser light source.

9. The lighting apparatus of claim 1,
wherein the structure comprise phosphor that is contained in the at least one light wavelength conversion element.

10. The lighting apparatus of claim 9,
wherein a thickness of the at least one light wavelength conversion element or a concentration of the phosphor in the at least one light wavelength conversion element is locally different.

11. The lighting apparatus of claim 9,
wherein a shape of a region of the at least one light wavelength conversion element having a locally different thickness of the at least one light wavelength conversion element or having a locally different concentration of the phosphor in the at least one light wavelength conversion element is coordinated with a shape of a luminous spot generated by the at least one laser light source on the at least one light wavelength conversion element or with a profile of the laser light generated by the at least one laser light source.

12. The lighting apparatus of claim 1,
wherein the structure comprises a thermal-radiation-reflecting coating of the light wavelength conversion element.

13. The lighting apparatus of claim 1,
wherein the structure comprises illumination means configured in such a way that they illuminate the at least one light wavelength conversion element with light having a wavelength the same as or similar to that of the laser light from the at least one laser light source.

14. The lighting apparatus of claim 1,
wherein at least one laser diode device and the at least one light wavelength conversion element are configured in such a way that they generate white light that is a mixture of laser light emitted by the at least one laser diode device and light wavelength-converted by the at least one light wavelength conversion element.

15. A vehicle headlight comprising:
at least one lighting apparatus, comprising:
at least one laser light source; and
at least one light wavelength conversion element for wavelength conversion of laser light from the at least one laser light source;
wherein the lighting apparatus has a structure configured to homogenize light color of the light emitted by the lighting apparatus;
wherein at least one laser diode device and the at least one light wavelength conversion element are configured in such a way that they generate white light that is a mixture of laser light emitted by the at least one laser diode device and light wavelength-converted by the at least one light wavelength conversion element.
